(19) United States
(12) Patent Application Publication
(10) Pub. No.: US 2006/0086162 A1
(43) Pub. Date: Apr. 27, 2006

(54) Adapter structure for a removable lock core assembly

(75) Inventor: Chao-Ming Huang, Kaohsiung Hsien (TW)

Correspondence Address: BIRCH STEWART KOLASCH & BIRCH, PO BOX 747, FALLS CHURCH, VA, 22040-0747, US

(73) Assignee: Taiwan Fu Hsing Industrial Co., Ltd.

(21) Appl. No.: 10/972,422

(22) Filed: Oct. 26, 2004

(51) Int. Cl. E05B 13/10; E05B 9/04

(52) U.S. Cl. 70/224; 70/371

(57) ABSTRACT

An adapter structure for a removable lock core assembly includes a lock core assembly, an adapter member, a door lever and a tubular lock mechanism. The lock core assembly includes a distal end formed with a pair of connecting apertures. The adapter member includes a pair of connecting rods and an operational hole at its opposite ends. The door lever provides with an 8-shaped hole and a circular opening. The tubular lock mechanism has an actuating member for rotational movement. In assembling operation, the connecting rods of the adapter member are correspondingly inserted into the connecting apertures of the lock core assembly, and the combination of the lock core assembly with the adapter member is commonly received in the door lever through the 8-shaped hole. The actuating member of the tubular lock mechanism extends through the circular opening and thus connects with the operational hole of the adapter member.

### BACKGROUND OF THE INVENTION

1. Field of the Invention

The present invention relates to an adapter structure for a removable lock core assembly. Particularly, the present invention relates to the adapter structure for the removable lock core assembly suitable, for a tubular lock mechanism. More particularly, the present invention relates to the adapter structure for mechanically connecting the removable lock core assembly with an actuating member of the tubular lock mechanism.

2. Description of the Related Art

Taiwanese Patent Publication No. 298,240, entitled “Driving Mechanism for a Removable Lock Core Assembly (I),” discloses a lock core assembly, a door lever and a drive spindle. The lock core assembly generally includes a first distal end and a second distal end. The first end of the lock core assembly provides with a keyhole to allow insertion of a key while the second end of the lock core assembly providing with a pair of connecting apertures. Spaced between the connecting apertures is a predetermined distance. The construction of the door lever may be discussed in greater detail below.

Generally, the door lever includes an axial tube member having a first distal end and a second distal end. The first end of the axial tube provides with an 8-shaped hole while the second end of the axial tube providing with a circular opening communicated with the 8-shaped hole. In installing operation, the lock core assembly extends through the 8-shapted hole of the axial tube, and the drive spindle extends through the circular opening of the axial tube. The construction of the cylinder lock mechanism may be discussed in greater detail below.

Typically, the drive spindle is a cylindrical monolithic member including a first distal end and a second distal end at its opposite sides. The first distal end of the drive spindle provides with a pair of parallel connecting rods. Connected to the second distal end of the drive spindle is a cylinder lock mechanism. Through the circular opening and the 8-shaped hole of the axial tube of the door lever, the connecting rods of the drive spindle are correspondingly inserted into and engaged with the connecting apertures of the lock assembly for commonly rotational movement. Consequently, once a correct key member is inserted into the keyhole of the lock core assembly and turned about an axis of the lock core assembly, the lock core assembly is able to turn the drive spindle and the cylindrical lock mechanism in succession.

As discussed above, the lock core assembly is removable by detaching the connecting rods of the drive spindle from the connecting apertures of the lock core assembly and thus a new lock core assembly may replace the unwanted or jammed lock core assembly conveniently according to the needs.

However, either of the lock core assembly with the connecting apertures or the drive spindle with the connecting rods is generally suitable for the cylinder lock mechanism. Consequently, it is limited that the removable lock core assembly is only applied to the cylinder lock mechanism and not applied to other types of the lock mechanism. For instance, the lock core assembly of a tubular lock mechanism is lack of connecting apertures or connecting rods, and thus cannot be removable. In DIY (Do It Yourself) market, demands for self-assembling a tubular lock mechanism has been widely increased. Hence, there is a need for a DIY lock core assembly for assembling the tubular lock mechanism.

The present invention intends to provide an adapter structure for a removable lock core assembly to assemble to a tubular lock mechanism. The adapter structure mechanically connects the removable lock core assembly with an actuating member of the tubular lock mechanism provided in such a way to mitigate and overcome the above problem. For adjusting purpose an elastic member with a predetermined length combined with the adapter structure is provided for assembling various longitudinal distances of the removable lock core assembly. Thereby, it widens application scope of the removable lock core assembly and increases assembling reliability of the tubular lock mechanism.

### SUMMARY OF THE INVENTION

The primary objective of this invention is to provide an adapter structure for a removable lock core assembly to assemble to a tubular lock mechanism. Thereby, the adapter structure may widen application scope of the removable lock core assembly.

The secondary objective of this invention is to provide the adapter structure combined with an elastic member for adjusting various longitudinal distances of the removable lock core assembly to connect with a tubular lock mechanism.

The adapter structure for a removable lock core assembly in accordance with the present invention includes a lock core assembly, an adapter member, a door lever and a tubular lock mechanism. The lock core assembly includes a distal end formed with a pair of connecting apertures. The adapter member includes a pair of connecting rods and an operational hole at its opposite ends. The door lever provides with an 8-shaped hole and a circular opening. The tubular lock mechanism has an actuating member for rotational movement. In assembling operation, the connecting rods of the adapter member are correspondingly inserted into the connecting apertures of the lock core assembly, and the combination of the lock core assembly with the adapter member is commonly received in the door lever through the 8-shaped hole. The actuating member of the tubular lock mechanism extends through the circular opening and thus connects with the operational hole of the adapter member.

In a separate aspect of the present invention is that the adapter member includes a head portion and a pair of connecting rods fixed thereon.

In a further separate aspect of the present invention is that the adapter member includes a head portion and a leg portion. An inner threaded portion of the head portion screw-connects with an outer threaded portion of the leg portion.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings wherein:

FIG. 1 is an exploded perspective view of an adapter structure and a removable lock core assembly in accordance with an embodiment of the present invention;

FIG. 2 is a perspective view of the adapter structure for the removable lock core assembly in accordance with a first embodiment of the present invention;

FIG. 2A is an exploded perspective view of the adapter structure for the removable lock core assembly in accordance with a second embodiment of the present invention;

FIG. 2B is an exploded perspective view of the adapter structure for the removable lock core assembly in accordance with a third embodiment of the present invention;

FIG. 3 is an assembled cross-sectional view of the adapter structure mechanically connecting the removable lock core assembly with an actuating member of a tubular lock mechanism in accordance with the first embodiment of the present invention; and

FIG. 4 is an assembled cross-sectional view of the adapter structure mechanically connecting the removable lock core assembly with an actuating member of a tubular lock mechanism through an elastic member in accordance with the first embodiment of the present invention.

### DETAILED DESCRIPTION OF THE INVENTION

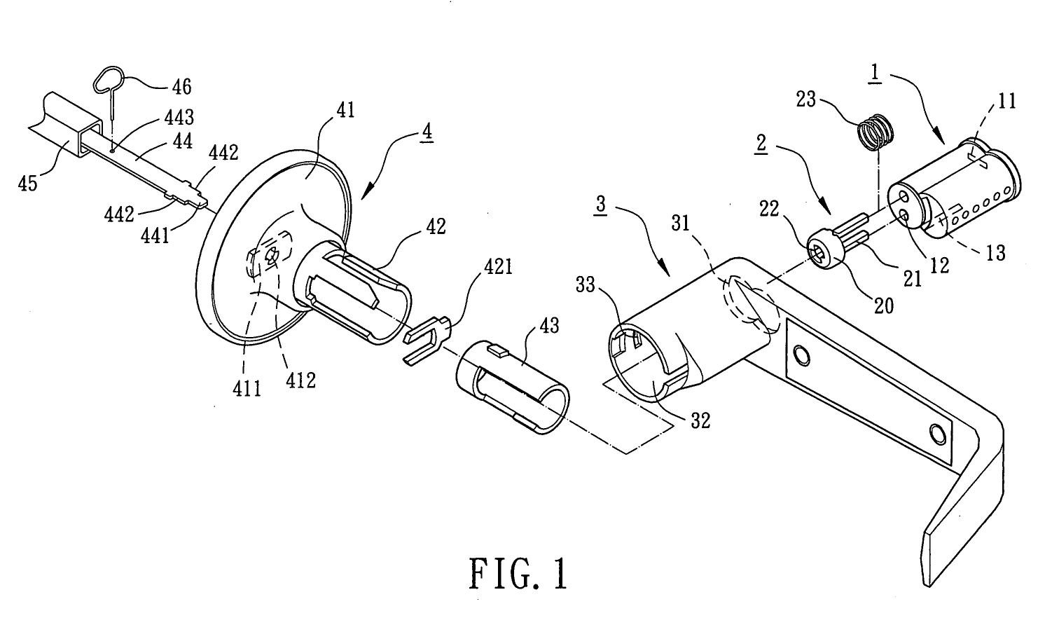

Referring initially to FIG. 1, it depicts an adapter structure for a removable lock assembly in accordance with an embodiment of the present invention. In this preferred embodiment, the adapter structure generally includes a lock core assembly designated numeral 1, an adapter member designated numeral 2, a door lever designated numeral 3 and a tubular lock mechanism designated numeral 4.

Still referring to FIGS. 1, the construction of the lock core assembly 1 shall be described in detail. The lock core assembly 1 is an elongated body with an 8-shaped cross-section. The lock core assembly 1 generally includes a first distal end and a second distal end. The first end of the lock core assembly 1 provides with a keyhole 11 to allow insertion of a key while the second end of the lock core assembly 1 providing with a pair of connecting apertures 12. Preferably, provided on an outer circumference of the lock core assembly 1 is an engaging protrusion 13 which is actuated to protrude or retract by a special key (not shown) for installing or detaching operation. Generally, various specifications of the lock core assembly 1 may be widely sold in DIY market and detailed descriptions thereof may be omitted.

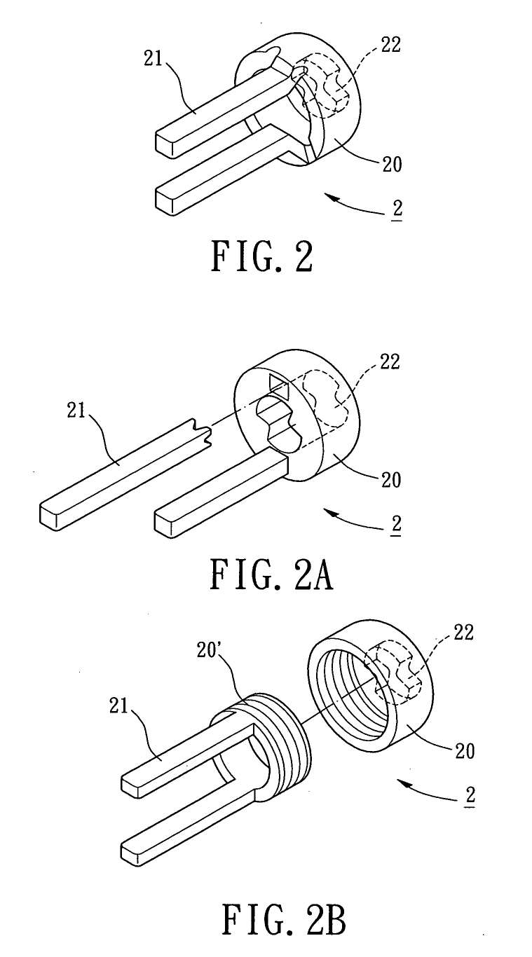

Turning now to FIG. 2, the construction of the adapter member 2 a first embodiment of the present invention shall be described in detail. Preferably, the adapter member 2 is a one-piece elongated member, and punched in a metallic plate relatively rigid and strong to withstand normal usage of the lock core assembly 1. The adapter member 2 at least includes a head portion 20. A first distal end of the head portion 20 provides with a pair of connecting rods 21 while a second distal end providing with an operational hole 22 as well as an 8-shaped hole. Outer circumferences of the two connecting rods 21 are slightly reduced from an outer circumference of the head portion 20 to constitute a stepped space to rest an elastic member 23 against the head portion 20. Preferably, a diameter of the elastic member 23 is slightly greater than a distance between the outer circumferences of the two connecting rods 21, and thus the elastic member 23 easily accommodates the connecting rods 21 of the adapter member 2 while assembling.

Turning now to FIG. 2A, reference numerals of the adapter member 2 in accordance with the second embodiment of the present invention have applied the identical numerals of the first embodiment, as shown in FIG. 2. The construction of the adapter member in accordance with the second embodiment of the present invention has similar configuration and same function as that of the first embodiment and detailed descriptions may be omitted.

Still referring to FIG. 2A, the head portion 20 of the adapter member 2 in accordance with the second embodiment of the present invention is a casting or a monolithic member molded by industrial plastic material. For ease manufacture each end of the separate connecting rods 21 inserts into and secures to the head portion 20 to constitute the adapter member 2.

Turning now to FIG. 2B, reference numerals of the adapter member in accordance with the third embodiment of the present invention have applied the identical numerals of the first embodiment, as shown in FIG. 2. The construction of the adapter member in accordance with the third embodiment of the present invention has similar configuration and same function as that of the first embodiment and detailed descriptions may be omitted.

Still referring to FIG. 2B, the head portion 20 of the adapter member 2 in accordance with the third embodiment of the present invention includes an inner threaded portion. Correspondingly, a leg portion 20′ includes an outer threaded portion adapted to combine with the inner threaded portion of the head portion 20. The leg portion 20′ further includes a pair of the connecting rods 21. In manufacture the leg portion 20′ screw-connects to the head portion 20 to constitute the adapter member 2.

Referring back to FIG. 1, the construction of the door lever 3 is shall be described in detail. Generally, the door lever 3 includes an axial tube member (not labeled) having a first distal end and a second distal end. The first end of the axial tube provides with an 8-shaped hole 31 while the second end of the axial tube providing with a circular opening 32 communicated with the 8-shaped hole 31. Preferably, a circumferential wall of the door lever 3 further includes a disassembling hole 33 for releasing the door lever 3 from the tubular lock mechanism 4.

Still referring to FIG, 1, the construction of the tubular lock mechanism 4 shall be described in detail. The tubular lock mechanism 4 includes an escutcheon rose 41, an axial tube 42, a spindle tube 43, an actuating member 44, a square tube 45 and a stop pin 46. The escutcheon rose 41 is coaxially connected with the axial tube 42 at its first end side and formed a sliding plate 411 at its second end side. In operation, the sliding plate 411 can be moved along a radial direction of the escutcheon rose 41 and provides with an 8-shaped hole 412 defined thereon. The axial tube 42 is able to rotate about an axis of the escutcheon rose 41 and provides with a guard plate 421. In assembling, the guard plate 421 of the tubular lock mechanism 4 is aligned with the disassembling hole 33 of the door lever 3 and thus release of the door lever 3 from the tubular lock mechanism 4, in locking situation, is not permitted. The axial tube 42 receives the spindle tube 43 in which to accommodate the lock core assembly 1. The actuating member 44 is a stick-like member, and includes a connecting end 441, a pair of lateral lugs 442 and a through hole 443 at its first end. A second end of the actuating member 44 is inserted into the square tube 45. The connecting end 441 of the actuating member 44 extends through the operational hole 22 of the adapter member 2. The lateral lugs 442 of the actuating member 44 are further aligned with guard plate 421. Meanwhile, the stop pin 46 of the tubular lock mechanism 4 extends through the through hole 443 of the actuating member 44 that prevents releasing the actuating member 44 from the escutcheon rose 41.

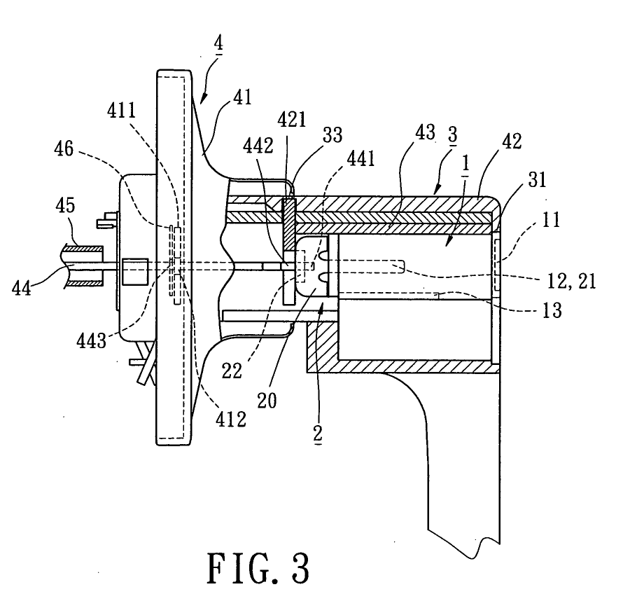

Turning now to FIG. 3, in assembling, the removable lock core assembly 1 is a 7-pin type lock core. Generally, the lock core assembly 1 is divided into a 6-pin type lock core and a 7-pin type lock core. In the beginning, the, connecting rods 21 of the adapter member 2 are correspondingly inserted into the connecting apertures 12 of the lock core assembly 1, and the combination of the lock core assembly 1 with the adapter member 2 is commonly received in the door lever 3 through the 8-shaped hole 31. For installing operation a special key (not shown) is inserted into the keyhole 11 to turn the lock core assembly 1 so that the engaging protrusion 13 of the lock core assembly 1 is engaged with the circumferential wall of the door lever 3. Consequently, the removable lock core assembly 1 securely connects with the door lever 3. The actuating member 44 is extended through the axial tube 42 and the 8-shaped hole 412 of the sliding plate 411 and inserted into the square tube 45. Additionally, the stop pin 46 of the tubular lock mechanism 4 extends through the through hole 443 of the actuating member 44 and engages with the sliding plate 411 that prevents releasing the actuating member 44 from the escutcheon rose 41. The axial tube 42 receives the spindle tube 43 and the combination of the axial tube 42 with the spindle tube 43 is inserted into the circular opening 32 of the door lever 3. The guard plate 421 employs an elastic plate (not shown) for elastically engaging with the disassembling hole 33 of the door lever 3. The connecting end 441 of the actuating member 44 extends through the operational hole 22 of the adapter member 2, thereby the actuating member 44 actuating the lock core assembly 1 through the adapter member 2. The lateral lugs 442 of the actuating member 44 are aligned with guard plate 421 that prevents releasing the door lever 3 from the tubular lock mechanism 4 in locking situation. After initially assembling, a predetermined specification of the removable lock core assembly 1 employs the adapter member 2 to connect to the door lever 3 and the tubular lock mechanism 4. Consequently, the removable lock core assembly 1 is suitable for assembling with the tubular lock mechanism 4 in addition to the cylinder lock mechanism. Thereby, the adapter member 2 widens application scope of the removable lock core assembly 1.

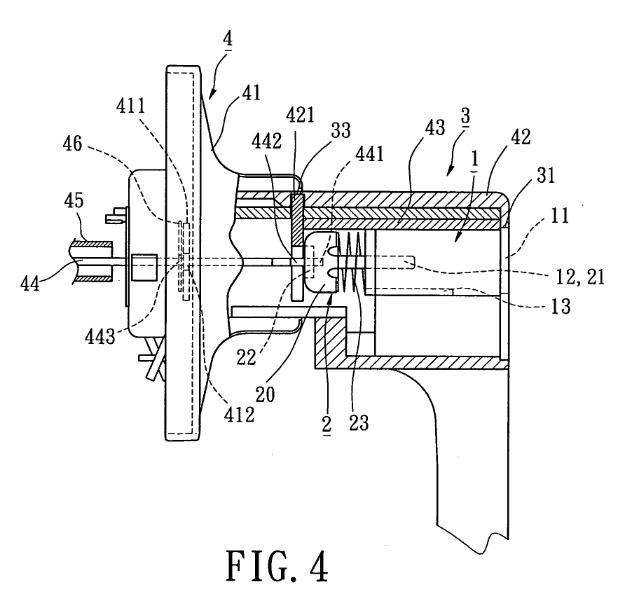

Referring back to FIG. 4, the adapter member 2 can further employ the elastic member 23 combined with the connecting rods 21 when the removable lock core assembly 1 has a shorter distance, a 6-pin type lock core for example. The elastic member 23 may bias and adjust the adapter member 2 that insures the connecting end 441 of the actuating member 44 to connect with the operational hole 22 of the adapter member 2. Thereby, the elastic member 23 permits the adapter member 2 to assemble with various longitudinal distances of the removable lock core assembly 1. Consequently, it widens application scope of the removable lock core assembly 1 and increases assembling reliability of the tubular lock mechanism 4.

It will be apparent from the aforementioned discussions that the conventional lock core assembly is only suitable for the cylinder lock mechanism and unsuitable for other types of the lock mechanism. However, the lock core assembly disclosed in TWN No. 298,240 is inevitably unsuitable for the tubular lock mechanism. As best shown in FIG. 1, the adapter member 2 and the elastic member 23 permits the removable lock core assembly 1 to assemble with the tubular lock mechanism 4 that may widen application scope of the removable lock core assembly 1 and increase assembling reliability of the tubular lock mechanism 4.

Although the invention has been described in detail with reference to its presently preferred embodiment, it will be understood by one of ordinary skill in the art that various modifications can be made without departing from the spirit and the scope of the invention, as set forth in the appended claims.

1. A removable lock core assembly comprising:
a removable lock core including a keyhole at its first distal end and a pair of connecting apertures at its second distal end;
an adapter member including a pair of connecting rods and an operational hole, the connecting rods are integrally formed on the adapter member and adapted to insert into the corresponding connecting apertures of the removable lock core for commonly rotational movement, said adapter member further including a head portion, the connecting rods being provided on a first distal end of the head portion and the operational hole being provided on a second distal end of the head portion; said adapter member being constructed from a one-piece elongated member, and punched in a metallic plate;
a door lever including an 8-shaped hole at its first distal end and a circular opening at its second distal end, the combination of the removable lock core and the adapter member inserted into the 8-shaped hole; and
a tubular lock mechanism provided with an actuating member extending through the circular opening of the door lever and engaging with the operational hole of the adapter member that the removable lock core, the adapter member, the door lever and the tubular lock mechanism are assembled.

2. The removable lock core assembly as defined in claim 1, wherein the operational hole of the adapter member is an 8-shaped hole.

3. (canceled)

4. The removable lock core assembly as defined in claim 1, wherein outer circumferences of the connecting rods slightly reduced from an outer circumference of the head portion to constitute a stepped space to rest an elastic member against the head portion.

5. The adapter structure for the removable lock core assembly as defined in claim 1, wherein each end of the separate connecting rods inserts into and secures to the head portion to constitute the adapter member.

6. A removable lock core comprising:
a removable lock core including a keyhole at its first distal end and a pair of connecting apertures at its second distal end;
an adapter member including a pair of connecting rods and an operational hole, the connecting rods are adapted to insert into the corresponding connecting apertures of the removable lock core for commonly rotational movement;
a door lever including an 8-shaped hole at its first distal end and a circular opening at its second distal end, the combination of the removable lock core and the adapter member inserted into the 8-shaped hole; and
a tubular lock mechanism provided with an actuating member extending through the circular opening of the door lever and engaging with the operational hole of the adapter member that the removable lock core, the adapter member, the door lever and the tubular lock mechanism are assembled;
wherein the adapter member further including a head portion; the connecting rods being provided on a first distal end of the head portion, and the operational hole being provided on a second distal end of the head portion;
wherein the adapter member further includes a leg portion and an outer threaded portion thereof adapted to combine with an inner threaded portion of the head portion.

7. (canceled)

8. The removable lock core assembly as defined in claim 1, wherein an outer circumference of the lock core assembly is provided with an engaging protrusion which is actuated to protrude or retract by a key for installing or detaching operation.

9. The removable lock core assembly as defined in claim 1, wherein the tubular lock mechanism includes an escutcheon rose, an axial tube, a spindle tube and a square tube; wherein the escutcheon rose is provided with a sliding plate; wherein the axial tube and the spindle tube are commonly inserted into the circular opening of the door lever; wherein the actuating member successively extended through the sliding plate of the escutcheon rose and the square tube.

10. The removable lock core assembly as defined in claim 9, wherein the tubular lock mechanism further includes a stop pin extending through a through hole of the actuating member and engaging with the sliding plate that prevents releasing the actuating member from the escutcheon rose.

11. An adapter structure for a removable lock core assembly comprising:
an adapter member including a pair of connecting rods and an operational hole, the connecting rods being integrally formed on the adapter member and adapted to insert into corresponding connecting apertures of a removable lock core for commonly rotational movement;
said adapter member further including a head portion, the connecting rods being provided on a first distal end of the head portion and the operational hole being provided on a second distal end of the head portion,
said adapter member being constructed from a one-piece elongated member, and punched in a metallic plate.

12. The adapter structure for a removable lock core assembly as defined in claim 11, wherein the adapter member having an operational hole.

13. An adapter structure for a removable lock core assembly comprising:
an adapter member including a pair of connecting rods and an operational hole, the connecting rods being adapted to insert into corresponding connecting apertures of a removable lock core for commonly rotational movement,
said adapter member further including a head portion, the connecting rods being provided on a first distal end of the head portion and the operational hole being provided on a second distal end of the head portion,
said adapter member further including a leg portion and an outer threaded portion thereof adapted to combine with an inner threaded portion of the head portion.

14. The adapter structure for a removable lock core assembly as defined in claim 13, wherein the adapter member having an operational hole.
